(19) United States
(12) Patent Application Publication
(10) Pub. No.: US 2024/0236635 A9
(43) Pub. Date: Jul. 11, 2024

(54) COMMUNICATION TERMINAL, MONITORING METHOD, AND NON-TRANSITORY COMPUTER READABLE MEDIUM

(71) Applicant: NEC Corporation, Minato-ku (JP)

(72) Inventors: Motoharu Ohtake, Tokyo (JP); Kosel Kobayashi, Tokyo (JP); Hiroaki Aminaka, Tokyo (JP); Shinji Miyazaki, Tokyo (JP); Tomoaki Nakanishi, Tokyo (JP)

(73) Assignee: NEC Corporation, Minato-ku, Tokyo (JP)

(21) Appl. No.: 18/278,466

(22) PCT Filed: Mar. 31, 2021
(86) PCT No.: PCT/JP2021/013812

§ 371 Date: Aug. 23, 2023

(51) Int. Cl. H04W 4/90; H04M 1/72424; H04M 1/72463; H04M 1/72484

(52) U.S. Cl. CPC H04W 4/90; H04M 1/72424; H04M 1/72463; H04M 1/72484

(57) ABSTRACT

It is intended to provide a communication terminal capable of preventing an operator of the communication terminal from recognizing processing running in the communication terminal. A communication terminal (10) according to the present disclosure includes a communication unit (11) that transmits an emergency message and a control unit (12) that disables a user's operation of the communication terminal or a function executed by a user's operation of the communication terminal after the emergency message is transmitted, and the communication unit (11) starts data communication with a monitoring terminal and transmits data to the monitoring terminal while the function is disabled.

### TECHNICAL FIELD

The present disclosure relates to a communication terminal, a monitoring method, and a program.

### BACKGROUND ART

In some cases, a person having a communication terminal wishes to perform communication with another communication terminal by using their communication terminal without being noticed by people around them. For example, when a bank robbery occurs in financial institutions such as a bank, the case can be possibly solved early if a bank clerk or a customer provides the police or a security company with information by using the communication terminal without being noticed by robbers.

According to Patent Literature 1, after a mobile communication terminal transmits an emergency message and while it is operating in emergency mode, the backlight of the mobile communication terminal does not work until an end key is entered. Further, while the mobile communication terminal is operating in emergency mode, its sound is muted. With this operation of the mobile communication terminal, a criminal cannot recognize the fact that the mobile communication terminal has transmitted an emergency message.

### CITATION LIST

### Patent Literature

Published Japanese Translation of PCT International Publication for Patent Application, No. 2008-544627

### SUMMARY OF INVENTION

### Technical Problem

However, a criminal can turn on the backlight and unmute the sound by handling the end key of the mobile communication terminal disclosed in Patent Literature 1. Therefore, there is a possibility that the criminal who gets the mobile communication terminal disclosed in Patent Literature 1 recognizes the mobile communication terminal operating in emergency mode.

In view of the above-described problem, an object of the present disclosure is to provide a communication terminal, a monitoring method, and a program capable of preventing an operator of the communication terminal from recognizing processing running in the communication terminal.

### Solution to Problem

A communication terminal according to a first aspect of the present disclosure includes a communication unit configured to transmit an emergency message; and a control unit configured to disable a user's operation of the communication terminal or a function executed by a user's operation of the communication terminal after the emergency message is transmitted, wherein the communication unit starts data communication with a monitoring terminal and transmits data to the monitoring terminal while the operation or the function is disabled.

A monitoring method according to a second aspect of the present disclosure includes transmitting an emergency message; disabling a user's operation of a communication terminal or a function executed by a user's operation of the communication terminal after the emergency message is transmitted; and starting data communication with a monitoring terminal and transmitting data to the monitoring terminal while the operation or the function is disabled.

A program according to a third aspect of the present disclosure causes a computer to execute transmitting an emergency message; disabling a user's operation of a communication terminal or a function executed by a user's operation of the communication terminal after the emergency message is transmitted; and starting data communication with a monitoring terminal and transmitting data to the monitoring terminal while the operation or the function is disabled.

### Advantageous Effects of Invention

According to the present disclosure, there are provided a communication terminal, a monitoring method, and a program capable of preventing an operator of the communication terminal from recognizing processing running in the communication terminal.

### BRIEF DESCRIPTION OF DRAWINGS

FIG. 1 is a block diagram of a communication terminal according to a first example embodiment;

FIG. 2 is a block diagram of a communication system according to a second example embodiment;

FIG. 3 is a block diagram of a communication terminal according to the second example embodiment;

FIG. 4 is a block diagram of a monitoring terminal according to the second example embodiment;

FIG. 5 is a view showing the flow of a control process in an emergency in the communication terminal according to the second example embodiment;

FIG. 6 is a view showing the flow of a control process in an emergency in the communication terminal according to the second example embodiment;

FIG. 7 is a view showing the flow of a monitoring process of the communication terminal in the communication system according to the second example embodiment;

FIG. 8 is a view showing the flow of a monitoring process of the communication terminal in the communication system according to the second example embodiment;

FIG. 9 is a block diagram of the communication terminal according to each example embodiment; and

FIG. 10 is a block diagram of the monitoring terminal according to each example embodiment.

### EXAMPLE EMBODIMENT

### First Example Embodiment

Example embodiments of the present invention will be described hereinafter with reference to the drawings. A configuration example of a communication terminal 10 according to a first example embodiment will be described with reference to FIG. 1. The communication terminal 10 may be a computer device that operates when a processor executes a program stored in a memory. The communication terminal 10 may be a smartphone terminal, a tablet terminal, or a portable terminal such as a wristwatch terminal, for example. Alternatively, the communication terminal 10 may be a laptop or desktop computer device.

The communication terminal 10 includes a communication unit 11 and a control unit 12. The communication unit 11 and the control unit 12 may be software or module whose processing is performed when a processor executes a program stored in a memory. Alternatively, the communication unit 11 and the control unit 12 may be hardware such as a circuit or a chip.

The communication unit 11 transmits an emergency message. The communication unit 11 transmits an emergency message when it detects a calling operation for making an emergency call by a user of the communication terminal 10. A user might make an emergency call when they encounter or get involved in a bank robbery, airplane hijack, bus hijack, taxi robbery and the like, for example. The communication unit 11 may transmit the emergency message to a destination input by a user. Alternatively, when a destination is not input by a user, the communication unit 11 may transmit the emergency message to a prestored destination. The communication unit 11 may transmit the emergency message to a different destination depending on the description of an incident input by a user. The destination of the emergency message may be the police, the fire department, or another agency, for example.

The communication unit 11 may transmit the emergency message autonomously without the calling operation by a user. For example, the communication unit 11 may transmit the emergency message according to a sensing result of a sensor that detects the surrounding environment of the communication terminal 10. For example, the communication unit 11 may transmit the emergency message when it detects a noise, an impact or the like. The communication unit 11 may transmit the emergency message to a different destination depending on a detection result of the sensor.

The control unit 12 disables a user's operation of the communication terminal 10 or a function executed by a user's operation of the communication terminal 10 after the emergency message is transmitted from the communication unit 11. A user usually runs a function built into the communication terminal 10 by a button operation on the communication terminal 10 or a touch operation that moves a finger on a display. Disabling a user's operation of the communication terminal 10 may be disabling operation information to be input to the communication terminal 10 when a user operates the communication terminal 10, for example.

The function executed by a user's operation of the communication terminal 10 may be a function of adjusting the volume of sounds such as a phone call, a sound output from a video, an operation sound and a ringtone, for example. The function of adjusting the volume includes a function of muting the sound or a function of unmuting the sound. The function executed by a user's operation of the communication terminal 10 may be a screen display function. Further, the function executed by a user's operation of the communication terminal 10 may include a function of activating, deactivating or switching an application installed in the communication terminal 10, a function of photographing with a camera, a function of collecting the surrounding sounds with a microphone and the like. The function executed by a user's operation of the communication terminal 10 may include a function of controlling the power supply such as turning on or off the power. The function executed by a user's operation of the communication terminal 10 may include control related to communication executed by the communication terminal 10, such as turning on or off mobile communication and turning on or off flight mode.

By disabling the function of adjusting the volume, the state where no sound is output from the speaker of the communication terminal 10 may be maintained, for example. Further, by disabling the screen display function, the state where nothing is displayed on the screen may be maintained, for example.

The control unit 12 may disable a part of all functions executed by a user's operation of the communication terminal 10. The control unit 12 may previously determine a function to be disabled after the emergency message is transmitted. In this case, the control unit 12 may disable the predetermined function when it detects that the emergency message is transmitted from the communication unit 11.

Further, the control unit 12 may keep a function executed by remote control from another communication terminal through a network, for example, rather than a function executed by a user's operation of the communication terminal 10, enabled. Another communication terminal that performs remote control is referred to as a monitoring terminal. For example, the control unit 12 may enable the monitoring terminal to turn on and off the camera function or the microphone function of the communication terminal 10 through a network. Further, the control unit 12 may enable the communication terminal 10 to transmit surrounding information collected using the camera function, the microphone function or the like to the monitoring terminal in response to a request from the monitoring terminal. This allows the monitoring terminal to collect the surrounding information of the communication terminal 10 by remote control. Thus, a function executed by a user's operation of the communication terminal 10 may be a function that is executed when a user directly operates the communication terminal 10. The condition that a user directly operates the communication terminal 10 may be that a user directly picks up and operates the communication terminal 10

While a function executed by a user's operation of the communication terminal 10 is disabled, the communication unit 11 starts data communication with the monitoring terminal and transmits data to the monitoring terminal. Starting data communication may be establishing a communication line between the communication terminal 10 and the monitoring terminal so that data communication is executable. The communication unit 11 may transmit predetermined data to the monitoring terminal or transmit data requested form the monitoring terminal to the monitoring terminal.

As described above, the communication terminal 10 disables a user's operation of the communication terminal 10 or a function executed by a user's operation of the communication terminal 10 in the event of an emergency such as when transmitting an emergency message. For example, a user who picks up the communication terminal 10 where nothing is displayed on the screen cannot recognize that the communication terminal 10 is operating. This reduces the possibility that, when a user who picks up the communication terminal 10 is a criminal, the criminal notices that the surrounding information of the communication terminal 10 is transmitted to the monitoring terminal through the communication terminal 10. Further, even if the criminal notices that some form of monitoring is carried out through the communication terminal 10 and operates the communication terminal 10, the function of the communication terminal 10 is not executable. Thus, the criminal is unable to stop the monitoring function by the monitoring terminal. This allows the monitoring terminal to continue to monitor the criminal.

### Second Example Embodiment

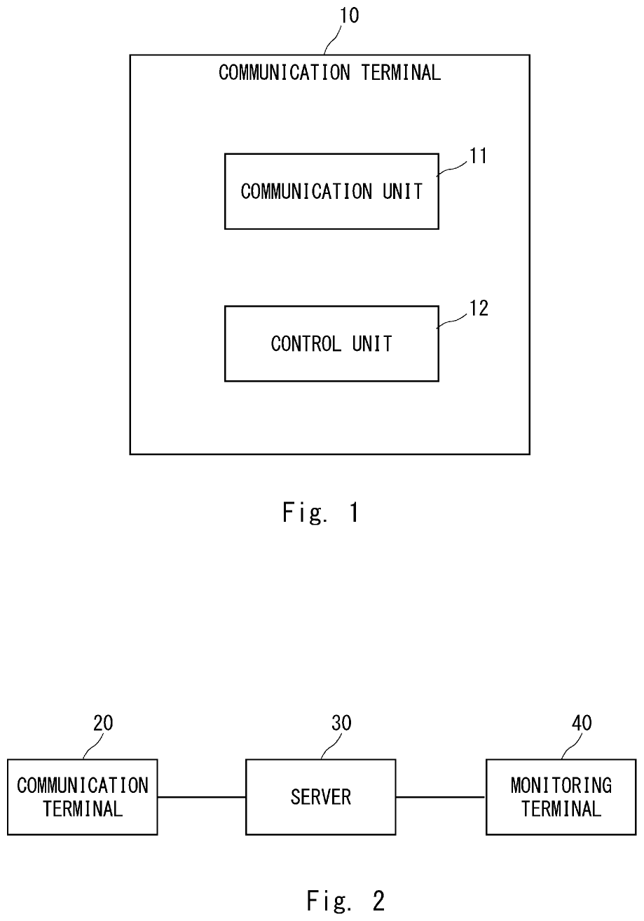

A configuration example of a communication system according to a second example embodiment will be described with reference to FIG. 2. The communication system in FIG. 2 includes a communication terminal 20, a server 30, and a monitoring terminal 40. The communication terminal 20 is equivalent of the communication terminal 10 in FIG. 1. The server 30 and the monitoring terminal 40 may be computer devices that operate when a processor executes a program stored in a memory. The server 30 is a server that executes processing for enabling communication of the communication terminal 20 and the monitoring terminal 40, and it may be a call server, for example. For example, the server 30 may perform call control using SIP (Session Initiation Protocol) to enable data communication between the communication terminal 20 and the monitoring terminal 40. The call control using SIP may be making incoming and outgoing calls by the communication terminal 20 and the monitoring terminal 40 and thereby establishing a session between the communication terminal 20 and the monitoring terminal 40, for example.

Further, the server 30 may relay data transmitted between the communication terminal 20 and the monitoring terminal 40. Data transmitted between the communication terminal 20 and the monitoring terminal 40 may be text data, sound data, image data, video data and the like. Alternatively, the communication terminal 20 and the monitoring terminal 40 may transmit and receive data on an IP network without going through the server 30. In other words, the communication terminal 20 and the monitoring terminal 40 may communicate with each other without the server 30 once a session between the communication terminal 20 and the monitoring terminal 40 is established by call control through the server 30.

The monitoring terminal 40 collects data from the communication terminal 20 and thereby monitors the surrounding circumstances of the communication terminal 20. For example, when a bank robbery or barricaded case occurs, a police agency that operates the monitoring terminal 40 may collect various data from the communication terminal 20 located at the scene of the crime and thereby analyze the scene of the crime. For example, the monitoring terminal 40 may collect image or video data taken by the communication terminal 20. Alternatively, the monitoring terminal 40 may collect sound data of the surrounding sounds of the communication terminal 20 detected by the microphone of the communication terminal 20.

The communication terminal 20 may transmit data generated in the communication terminal 20 to the monitoring terminal 40 in response to a request from the monitoring terminal 40. Further, it is necessary to prevent a criminal from noticing that the communication terminal 20 is transmitting data to the monitoring terminal 40. Therefore, for example, the communication terminal 20 may keep the screen blackout mode so that the backlight of the screen does not turn on. Alternatively, the communication terminal 20 may mute the sound so that the surrounding sounds of the monitoring terminal 40 are not output from the speaker.

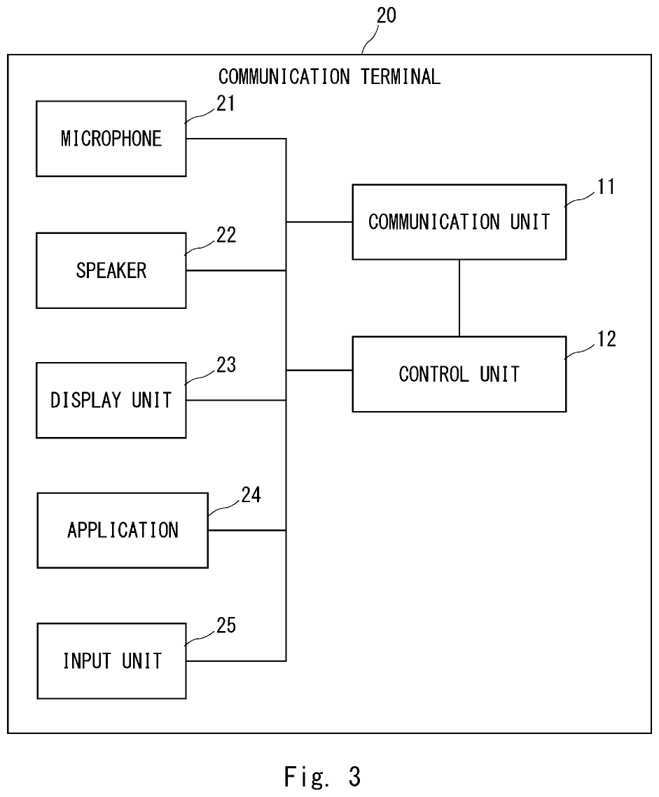

A configuration example of the communication terminal 20 according to the second example embodiment will be described with reference to FIG. 3. The communication terminal 20 has a configuration in which a microphone 21, a speaker 22, a display unit 23, an application 24, and an input unit 25 are added to the configuration of the communication terminal 10 shown in FIG. 1. In the following description of the communication terminal 20, the description of the elements common to those of the communication terminal 10 will be omitted.

The display unit 23 may be a liquid crystal display, an organic EL (Electro Luminescence) display or the like, for example. For example, a user of the communication terminal 20 may select an application to use from a plurality of applications 24 displayed on the display unit 23. A user activates an application by a click, tap or touch (hereinafter referred to as a touch operation), for example.

A user of the communication terminal 20 may adjust the volume of the sound to be output from the speaker 22 by operating a button physically placed on the communication terminal 20. Alternatively, a user of the communication terminal 20 may select an application for adjusting the volume by a touch operation from the plurality of applications 24 displayed on the display unit 23 and adjust the volume of the sound to be output from the speaker 22. Adjusting the sound volume includes muting the sound and not outputting any sound from the speaker 22.

The input unit 25 may be an input interface that detects operation information by a user. For example, the input unit 25 may be a sensor that detects a user's touch operation or may be a mechanism that detects a user's button operation. Alternatively, the input unit 25 may be a text input interface for a user to input text. Alternatively, the microphone 21 that collects the surrounding sounds of a user who operates the communication terminal 20 or the communication terminal 20 may be included in the input unit 25.

The communication unit 11 transmits an emergency message to the server 30 when it receives a command to make an emergency call from a user through the input unit 25. When the control unit 12 detects that the emergency message is transmitted from the communication unit 11, it disables a function executed by a button operation or a touch operation performed by a user. Alternatively, when the control unit 12 detects that the emergency message is transmitted from the communication unit 11, it may disable a button operation or a touch operation performed by a user.

For example, after the communication unit 11 transmits the emergency message, the control unit 12 may turn off the backlight of the screen so that the screen is black out. In other words, the control unit 12 may disable the function of turning on the backlight of the screen. The control unit 12 may disable the function of turning on the backlight of the screen that is usually executed by a user's button operation or touch operation. Further, after the communication unit 11 transmits the emergency message, the control unit 12 may stop displaying on the display unit 23.

Further, after the communication unit 11 transmits the emergency message, the control unit 12 may disable the function of outputting the sound from the speaker 22 and mute the speaker 22. Further, the control unit 12 may disable the function of unmuting the speaker 22

Further, after the communication unit 11 transmits the emergency message, the control unit 12 may disable the activation of the new application 24 by a user's button operation or touch operation. After the communication unit 11 transmits the emergency message, the control unit 12 may disable the deactivation of the running application 24 by a user's button operation or touch operation. In other words, after the communication unit 11 transmits the emergency message, the control unit 12 may disable the function of activating or deactivating the application 24.

When the control unit 12 receives a monitoring end message from the monitoring terminal 40, the control unit 12 enables the function that has been disabled. Alternatively, the control unit 12 may start a timer when it disables a function executed by a user's operation of the communication terminal and, after the timer expires, enable the function that has been disabled. Further, when the control unit 12 receives the monitoring end message, it may turn on the screen that has been off and unmute the speaker.

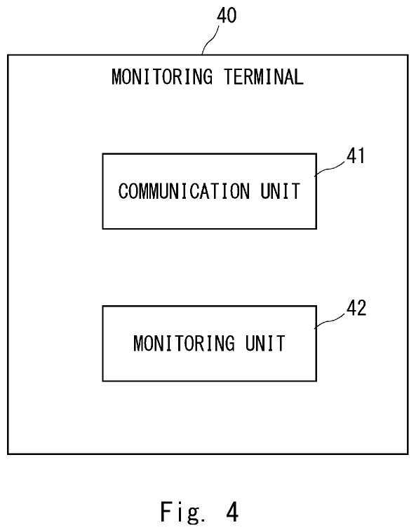

Next, a configuration example of the monitoring terminal 40 according to the second example embodiment will be described with reference to FIG. 4. The monitoring terminal 40 includes a communication unit 41 and a monitoring unit 42. The communication unit 41 and the monitoring unit 42 may be software or module whose processing is performed when a processor executes a program stored in a memory. Alternatively, the communication unit 41 and the monitoring unit 42 may be hardware such as a circuit or a chip.

The communication unit 41 receives an emergency message transmitted from the communication terminal 20 through the server 30. When the communication unit 41 receives the emergency message, the monitoring unit 42 transmits a monitoring command message to the communication terminal 20 through the communication unit 41 in order to monitor the communication terminal 20. The monitoring command message may contain the type of data desired to be collected, for example. The monitoring command message may contain a parameter indicating the transmission of at least one of text data, sound data, image data and video data to the monitoring terminal 40, for example. Further, the monitoring command message may contain a parameter, a message or the like indicating the activation of a camera, a microphone or the like in the communication terminal 20.

When ending the monitoring of the communication terminal 20, the monitoring unit 42 transmits a monitoring end message to the communication terminal 20 through the communication unit 41.

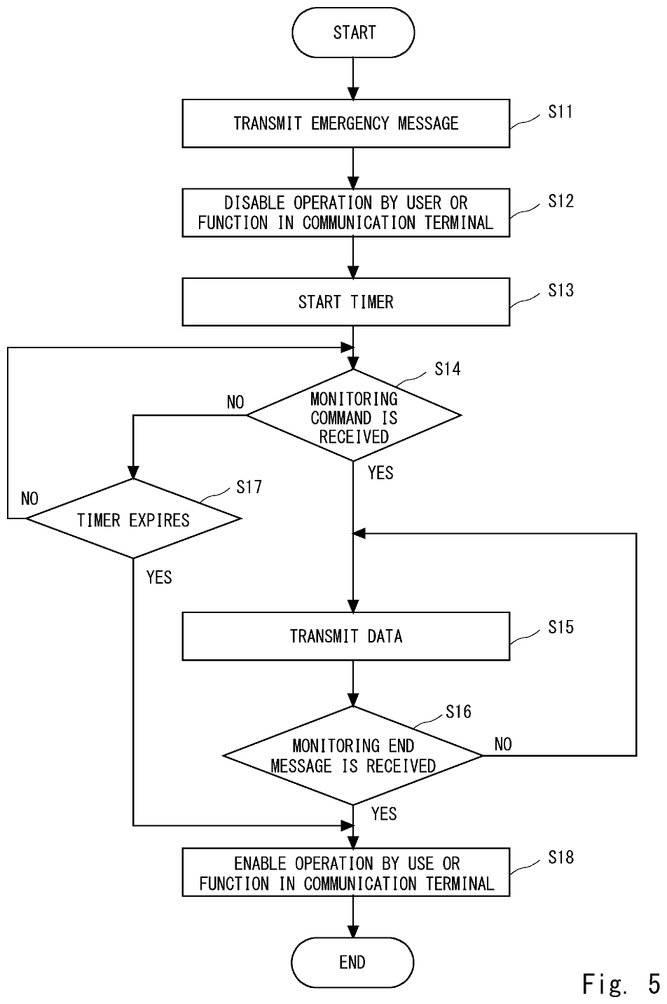

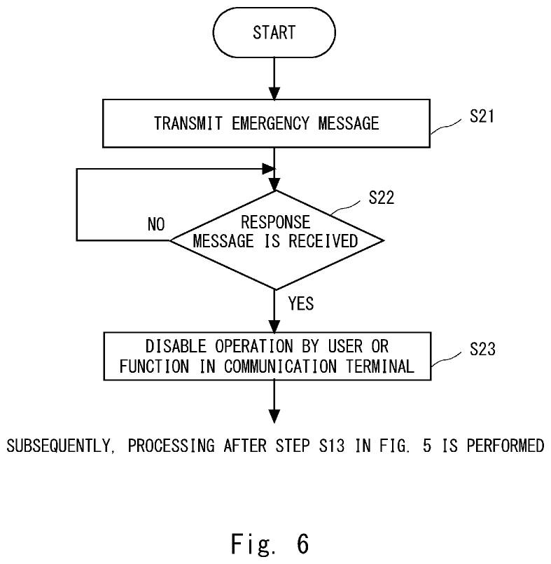

The flow of a control process in an emergency in the communication terminal 20 according to the second example embodiment will be described hereinafter with reference to FIG. 5. First, the communication unit 11 transmits, to the server 30, an emergency message addressed to the monitoring terminal 40 (S11). Alternatively, in the case where the server 30 determines a monitoring terminal to monitor the communication terminal 20, the communication terminal 20 may transmit, to the server 30, an emergency message addressed to the server 30.

Next, the control unit 12 disables a user's operation of the communication terminal 20 or a function executed by a user's operation of the communication terminal 20 (S12). The control unit 12 may disable all functions executed by a user's operation of the communication terminal 20, or may disable a part of all such functions.

Then, the control unit 12 starts a timer (S13). The timer started in Step S13 is used to avoid that the state of waiting for the monitoring command message from the monitoring terminal 40 continues endlessly. The control unit 12 then determines whether the monitoring command message is received from the monitoring terminal 40 or not (S14). When the control unit 12 determines that the monitoring command message is received from the monitoring terminal 40, the communication unit 11 transmits, to the monitoring terminal 40, data designated by the monitoring terminal 40 or predetermined data to be transmitted to the monitoring terminal 40 (S15). The control unit 12 then determines whether the monitoring end message is received or not (S16). When the control unit 12 determines that the monitoring end message is not received, it repeats the processing of Step S15. When, on the other hand, the control unit 12 determines that the monitoring end message is received, it enables a user's operation of the communication terminal 20 or a function in the communication terminal 20 that has been disabled (S18). In Step S14, when the control unit 12 determines that the monitoring command message is not received, it determines whether the timer has expired or not (S17). When the control unit 12 determines that the timer has not expired, it repeats the processing of Step S14. When, on the other hand, the control unit 12 determines that the timer has expired, it enables a user's operation of the communication terminal 20 or a function in the communication terminal 20 that has been disabled (S18).

The flow of a control process that is different from the flow of the control process in an emergency shown in FIG. 5 will be described hereinafter with reference to FIG. 6. First, the communication unit 11 transmits, to the server 30, an emergency message addressed to the monitoring terminal 40 (S21). The processing of Step S21 is the same as the processing of Step S11 in FIG. 5.

Next, the control unit 12 determines whether a response message to the emergency message is received from the monitoring terminal 40 in the communication unit 11 (S22). When the control unit 12 determines that the response message is not received, it repeats the processing of Step S22. When, on the other hand, the control unit 12 determines that the response message is received, it disables a user's operation of the communication terminal 20 or a function executed by a user's operation of the communication terminal 20 (S23). Further, the control unit 12 may repeat the processing of Step S22 a predetermined number of times, and end the process of FIG. 6 when it determines that the response message is not received. After the processing of Step S23 is performed, the processing after Step S13 in FIG. 5 is repeated.

The fact that the communication terminal 20 receives the response message to the emergency message from the monitoring terminal 40 indicates that the monitoring terminal 40 is in the state of being able to monitor the communication terminal 20. On the other hand, the fact that the monitoring terminal 40 does not receive the response message from the monitoring terminal 40 indicates that the monitoring terminal 40 is not in the state of being able to monitor the communication terminal 20. The situation where the monitoring terminal 40 is not in the state of being able to monitor the communication terminal 20 may be where failures are occurring in the monitoring terminal 40, the monitoring terminal 40 is not activated, the monitoring terminal 40 is not connected to a network or the like, for example.

When the monitoring terminal 40 is not in the state of being able to monitor the communication terminal 20, the communication terminal 20 does not transmit data to the monitoring terminal 40. Therefore, even if the communication terminal 20 is noticed by a bank robber or a barricaded criminal, no problem arises because the communication terminal 20 is not used for monitoring. Thus, by performing the processing of Step S22 in the control unit 12, the communication terminal 20 can be used as usual when there is no need to disable a user's operation of the communication terminal 20 or a function executed by a user's operation of the communication terminal 20.

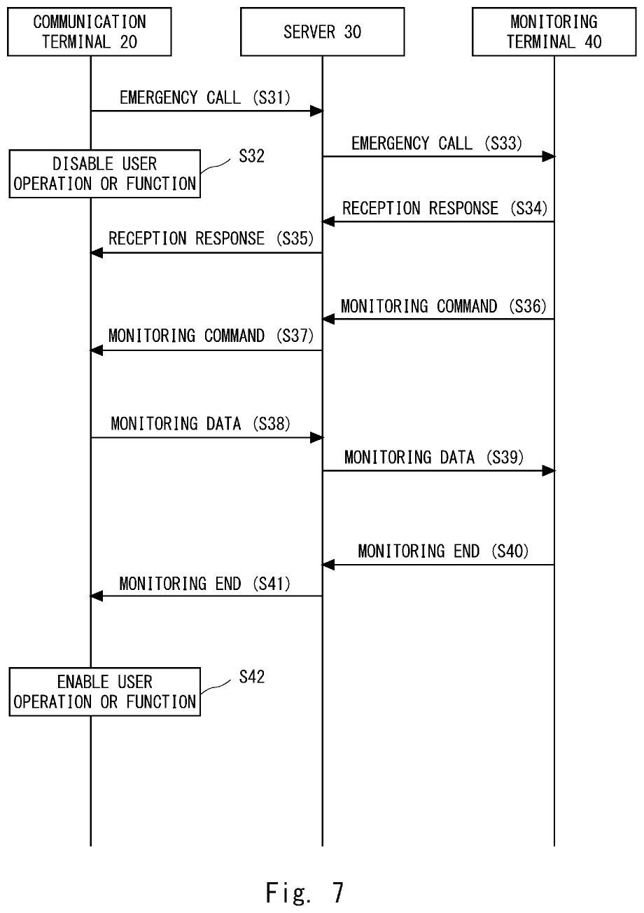

The flow of a monitoring process of the communication terminal 20 in the communication system according to the second example embodiment will be described hereinafter with reference to FIG. 7. First, the communication terminal 20 transmits, to the server 30, an emergency message (S31). After transmitting the emergency message, the communication terminal 20 disables a user's operation of the communication terminal 20 or a function executed by a user's operation of the communication terminal 20 (S32).

The server 30 receives the emergency message, and transmits the received emergency message to the monitoring terminal 40 (S33). When the monitoring terminal 40 is designated as the destination of the emergency message, the server 30 transmits the emergency message to the monitoring terminal 40. When, on the other hand, the monitoring terminal is not designated as the destination of the emergency message, the server 30 may select the monitoring terminal 40 from a list of monitoring terminals stored in advance, for example, and transmit the emergency message to the monitoring terminal 40.

For example, the communication terminal 20 may add positional information of the communication terminal 20 to the emergency message. Further, the server 30 may manage positional information and a monitoring terminal in association with each other. In this case, the server 30 may select the monitoring terminal 40 associated with the position of the communication terminal 20 contained in the emergency message and transmit the emergency message to this monitoring terminal 40.

Alternatively, the communication terminal 20 may add information indicating the details of a crime that is occurring to the emergency message. Further, the server 30 may manage the details of a crime and a monitoring terminal in association with each other. In this case, the server 30 may select the monitoring terminal 40 associated with the details of a crime contained in the emergency message and transmit the emergency message to this monitoring terminal 40.

Further, the communication terminal 20 may add information indicating connection priority to the emergency message. The connection priority may be the priority of processing related to a session between the server 30 and the communication terminal 20, for example. The processing related to a session between the server 30 and the communication terminal 20 may be reception processing related to a message received by the server 30 from the communication terminal 20 or transmission processing related to a message transmitted from the server 30 to the communication terminal 20, for example.

The server 30 may perform processing related to a session with the high connection priority in preference to others. The information indicating the connection priority may be QCI (QoS Class Identifier) or 5QI (5G QoS Indicator) indicating the QoS (Quality of Service) class in an LTE (Long Term Evolution) or 5G (5th Generation) system, for example. The server 30 may carry out priority control by using QCI or 5QI. Alternatively, the information indicating the connection priority may be DSCP (Differentiated Services Code Point) of an IP header, a priority tag of IEEE (Institute of Electrical and Electronics Engineers) 802.1Q or the like. The server 30 may carry out priority control by using DSCP or a priority tag. Further, when the server 30 does not apply the connection priority contained in the emergency message, it may process a message transmitted between the communication terminal 20 and the server 30 according to the connection priority determined by the server 30. Further, the server 30 may store connection priority information predetermined for the communication terminal 20 instead of receiving information indicating the connection priority from the communication terminal 20.

Then, the monitoring terminal 40 transmits, to the server 30, a reception response message as a response message to the emergency message (S34). The monitoring terminal 40 may add information indicating the connection priority to the reception response message. The connection priority may be the priority of processing related to a session between the server 30 and the monitoring terminal 40.

After that, the server 30 transmits the reception response message received from the monitoring terminal 40 to the communication terminal 20 (S35). By transmitting the reception response message from the server 30 to the communication terminal 20, a session between the communication terminal 20 and the server 30 and a session between the server 30 and the monitoring terminal 40 may be established. As a result that each session is established, the transmission and reception of sound data or the like become possible between the communication terminal 20 and the monitoring terminal 40 through the server 30.

Alternatively, a session between the communication terminal 20 and the monitoring terminal 40 may be established by transmitting the reception response message from the server 30 to the communication terminal 20. As a result that a session between the communication terminal 20 and the monitoring terminal 40 is established, the transmission and reception of sound data or the like may become possible between the communication terminal 20 and the monitoring terminal 40 without through the server 30. The flow of a process that establishes a session between the communication terminal 20 and the server 30 and a session between the server 30 and the monitoring terminal 40 is shown in FIG. 7.

After that, the monitoring terminal 40 transmits a monitoring command message to the server 30 in order to collect data from the communication terminal 20 (S36). The monitoring command message may contain information indicating the type of data to be transmitted from the communication terminal 20 to the monitoring terminal 40. Then, the server 30 transmits the monitoring command message received from the monitoring terminal 40 to the communication terminal 20 (S37).

Then, the communication terminal 20 transmits monitoring data to the monitoring terminal 40 according to the type of data to be transmitted to the monitoring terminal 40 contained in the monitoring command message or the predetermined type of data to be transmitted to the monitoring terminal 40 (S38). The monitoring data may contain at least one of text data, sound data, image data and video data, for example. Further, when the transmission of positional information of the communication terminal 20 is indicated by the monitoring command message, the monitoring data may contain the positional information of the communication terminal 20. The server 30 transmits the received monitoring data to the monitoring terminal 40 (S39).

Then, when ending the monitoring of the communication terminal 20 after completing the analysis or the like of the monitoring data, the monitoring terminal 40 transmits a monitoring end message to the server 30 (S40). The server 30 transmits the monitoring end message received from the monitoring terminal 40 to the communication terminal 20 (S41).

The communication terminal 20 receives the monitoring end message and enables a user's operation of the communication terminal 20 or a function of the communication terminal 20 that has been disabled in Step S32 (S42). In other words, when the communication terminal 20 receives the monitoring end message, it enables various functions to be executed according to a user's operation of the communication terminal 20.

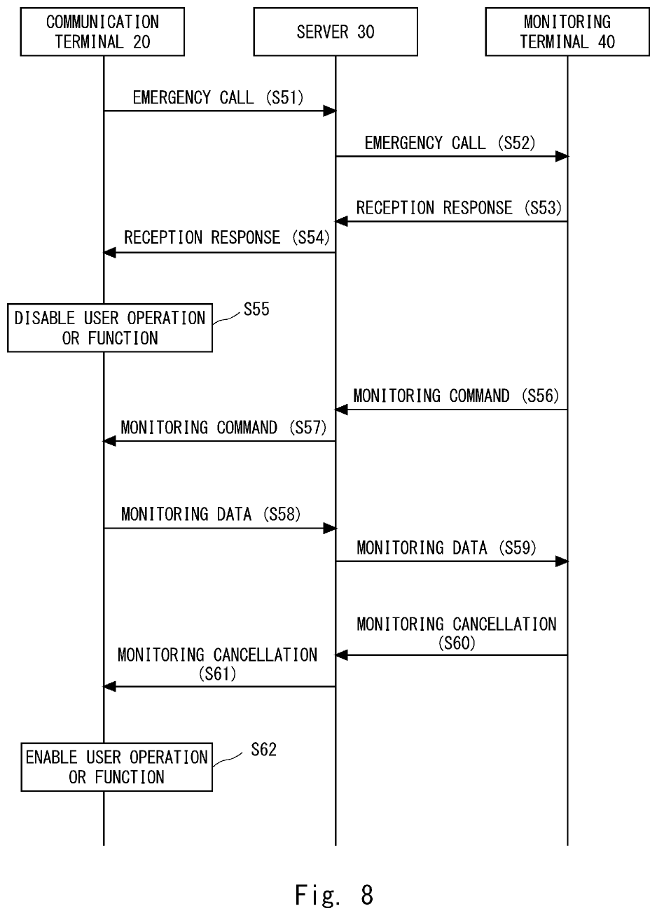

The flow of a monitoring process different from that shown in FIG. 7 will be described hereinafter with reference to FIG. 8. Steps S51 to S54 in FIG. 8 are the same as Steps S31 and S33 to S35 in FIG. 7, and therefore the detailed description thereof is omitted. In FIG. 7, processing of disabling a user's operation of the communication terminal 20 or a function executed by a user's operation of the communication terminal 20 in Step S32 is performed before the communication terminal 20 receives the reception response message in Step S35. On the other hand, in the monitoring process in FIG. 8, processing of disabling a user's operation of the communication terminal 20 or a function executed by a user's operation of the communication terminal 20 in Step 55 is performed after the communication terminal 20 receives the reception response message.

Steps S56 to S62 in FIG. 8 are the same as Steps S36 to S42 in FIG. 7, and therefore the detailed description thereof is omitted.

Further, in FIGS. 7 and 8, a process in which the monitoring terminal 40 transmits the reception response message to the communication terminal 20 after the monitoring terminal 40 receives the emergency message is described. In FIGS. 7 and 8, a session between the communication terminal 20 and the server 30 and a session between the server 30 and the monitoring terminal 40 are established as a result that the communication terminal 20 and the monitoring terminal 40 transmit and receive the emergency message and the reception response message. In other words, the emergency message and the reception response message are used as call messages with the communication terminal 20 serving as a caller terminal and the monitoring terminal 40 serving as a receiver terminal.

On the other hand, the monitoring terminal 40 may skip the transmission of the reception response message in response to the emergency message. Specifically, after the monitoring terminal 40 receives the emergency message, the monitoring terminal 40 as a caller terminal may transmit the monitoring command message to the communication terminal 20 as a receiver terminal. In this case, the communication terminal 20 may transmit a response message to the monitoring command message to the monitoring terminal 40. In this manner, the monitoring command message and the reception response message transmitted from the communication terminal 20 may be used as call messages.

Further, FIGS. 6 and 8 show that the communication terminal 20 performs processing of disabling a user's operation of the communication terminal 20 or a function executed by a user's operation of the communication terminal 20 after the communication terminal 20 receives the reception response message. Note that, however, the communication terminal 20 may perform processing of disabling a user's operation of the communication terminal 20 or a function executed by a user's operation of the communication terminal 20, triggered by reception of the monitoring command message rather than reception of the reception response message.

As described above, the communication terminal 20 according to the second example embodiment disables a user's operation of the communication terminal 20 or a function executed by a user's operation of the communication terminal 20 after transmitting an emergency message. Further, the communication terminal 20 transmits data to the monitoring terminal 40 in response to a command message received from the monitoring terminal 40. As a result, even if a bank robber or a barricaded criminal picks up the communication terminal 20, it is less likely that the criminal notices that the monitoring terminal 40 is monitoring the surrounding circumstances of the communication terminal 20 by using the communication terminal 20.

Further, even if a criminal notices that some form of emergency operation is being carried out in the communication terminal 20, the communication terminal 20 does not stop the transmission of monitoring data until it receives the monitoring end message from the monitoring terminal 40. Thus, even if a criminal operates the communication terminal 20, the transmission of monitoring data from the communication terminal 20 to the monitoring terminal 40 is not stoppable. Consequently, the monitoring terminal 40 is able to continue monitoring using the communication terminal 20.

Furthermore, as described with reference to FIGS. 6 and 8, the communication terminal 20 can disable a user's operation of the communication terminal 20 or a function executed by a user's operation of the communication terminal 20 after receiving a response message from the monitoring terminal 40. This allows disabling a user's operation of the communication terminal 20 or a function executed by a user's operation of the communication terminal 20 after the monitoring terminal 40 becomes the state of being able to monitor the communication terminal 20.

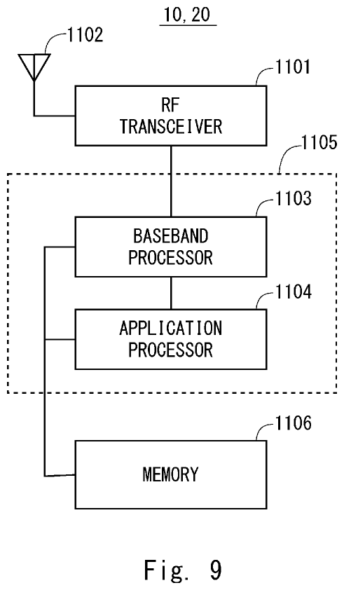

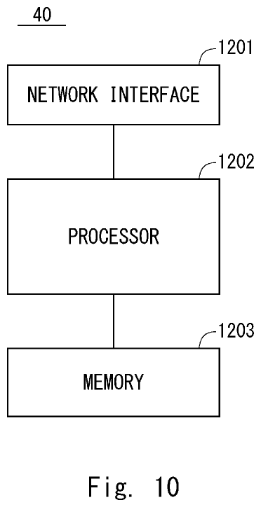

FIG. 9 is a block diagram showing a configuration example of the communication terminal 10 or the communication terminal 20 (which is referred to hereinafter as the communication terminal 10 etc.). A Radio Frequency (RF) transceiver 1101 performs analog RF signal processing for communication with a base station. Analog RF signal processing performed by the RF transceiver 1101 includes frequency up-conversion, frequency down-conversion, and amplification. The RF transceiver 1101 is connected to an antenna 1102 and a baseband processor 1103. Specifically, the RF transceiver 1101 receives modulated symbol data (or OFDM symbol data) from the baseband processor 1103, generates a transmission RF signal, and supplies the transmission RF signal to the antenna 1102. Further, the RF transceiver 1101 generates a baseband received signal based on a received RF signal received by the antenna 1102 and supplies it to the baseband processor 1103.

The baseband processor 1103 performs digital baseband signal processing (data plane processing) and control plane processing for radio communication. The digital baseband signal processing includes (a) data compression/decompression, (b) data segmentation/concatenation, (c) transmission format (transmission frame) composition/decomposition, (d) transmission path encoding/decoding, (e) modulation(symbol mapping)/demodulation, and (f) OFDM symbol data (baseband OFDM signal) generation by Inverse Fast Fourier Transform (IFFT) and the like. On the other hand, the control plane processing includes communication management of Layer 1 (e.g., transmission power control), Layer 2 (e.g., radio resource management and hybrid automatic repeat request (HARQ) processing), and Layer 3 (e.g., attach, mobility, and signaling related to call management).

For example, in the case of LTE and 5G, the digital baseband signal processing by the baseband processor 1103 may include signal processing of Packet Data Convergence Protocol (PDCP) layer, Radio Link Control (RLC) layer, MAC layer, and PHY layer. Further, the control plane processing by the baseband processor 1103 may include processing of Non-Access Stratum (NAS) protocol, RRC protocol, and MAC CE.

The baseband processor 1103 may include a modem processor (e.g., Digital Signal Processor (DSP)) that performs digital baseband signal processing and a protocol stack processor (e.g., Central Processing Unit (CPU) or Micro Processing Unit (MPU)) that performs control plane processing. In this case, the protocol stack processor that performs control plane processing may be made common to an application processor 1104, which is described below.

The application processor 1104 is also called a CPU, an MPU, a microprocessor or a processor core. The application processor 1104 may include a plurality of processors (a plurality of processor cores). The application processor 1104 implements each function of the communication terminal 10 etc. by running a system software program (Operating System (OS)) and various application programs (e.g., call application, web browser, mailer, camera control application, music playback application etc.) read from a memory 1106 or a memory which is not shown.

In some implementations, as shown in the dotted line (1105) in FIG. 9, the baseband processor 1103 and the application processor 1104 may be integrated into one chip. In other words, the baseband processor 1103 and the application processor 1104 may be implemented as one System on Chip (SoC) device 1105. The SoC device is also called a system Large Scale Integration (LSI) or a chip set in some cases.

The memory 1106 is a volatile memory, a nonvolatile memory, or a combination of them. The memory 1106 may include a plurality of memory devices that are physically independent of one another. The volatile memory is a Static Random Access Memory (SRAM), a Dynamic RAM (DRAM), or a combination of them, for example. The nonvolatile memory is a mask Read Only Memory (MROM), an Electrically Erasable Programmable ROM (EEPROM), a flash memory, a hard disk drive, or any combination of them, for example. For example, the memory 1106 may include an external memory device that is accessible from the baseband processor 1103, the application processor 1104 and the SoC 1105. The memory 1106 may include an internal memory device that is integrated into the baseband processor 1103, the application processor 1104 or the SoC 1105. Further, the memory 1106 may include a memory in a Universal Integrated Circuit Card (UICC).

The memory 1106 may store a software module (computer program) containing a group of instructions and data for performing the processing by the communication terminal 10 etc. described in the above plurality of example embodiments. In some implementations, the baseband processor 1103 or the application processor 1104 may be configured to perform the processing of the communication terminal 10 etc. described in the above example embodiments by reading the software module from the memory 1106 and executing it.

FIG. 10 is a block diagram showing a configuration example of the monitoring terminal 40. Referring to FIG. 10, the monitoring terminal 40 includes a network interface 1201, a processor 1202, and a memory 1203. The network interface 1201 may be used to communicate with another network node. The network interface 1201 may include a network interface card (NIC) that complies with the IEEE 802.3 series, for example.

The processor 1202 reads and runs software (computer program) from the memory 1203 and thereby executes processing of the monitoring terminal 40 that is described with reference to the flowchart in the example embodiments described above. The processor 1202 may be a microprocessor, an MPU or a CPU, for example. The processor 1202 may include a plurality of processors.

The memory 1203 is a combination of a volatile memory and a nonvolatile memory. The memory 1203 may include a storage that is placed apart from the processor 1202. In this case, the processor 1202 may access the memory 1203 through an I/O interface, which is not shown.

In the example of FIG. 10, the memory 1203 is used to store a group of software modules. The processor 1202 performs the processing of the monitoring terminal 40 described in the above example embodiments by reading the group of software modules from the memory 1203 and executing them.

As described with reference to FIG. 10, each of processors included in the monitoring terminal 40 in the above example embodiments runs one or a plurality of programs including a group of instructions for causing a computer to perform the algorithms described using the drawings.

In the above-described examples, the program can be stored and provided to a computer using any type of non-transitory computer readable medium. Non-transitory computer readable media include any type of tangible storage medium. Examples of the non-transitory computer readable media include magnetic storage media (e.g., flexible disks, magnetic tapes, hard disk drives, etc.), optical magnetic storage media (e.g. magneto-optical disks), CD-ROM (Read Only Memory), CD-R, CD-R/W, and semiconductor memories (e.g., mask ROM, PROM (Programmable ROM), EPROM (Erasable PROM), flash ROM, and RAM (Random Access Memory)). The program may be provided to a computer using any type of transitory computer readable medium. Examples of transitory computer readable media include electric signals, optical signals, and electromagnetic waves. The transitory computer readable medium can provide the program to a computer via a wired communication line such as an electric wire or an optical fiber, or a wireless communication line.

Note that the present disclosure is not limited to the above-described example embodiments and can be modified as appropriate without departing from the spirit and scope of the present disclosure.

### REFERENCE SIGNS LIST

10 COMMUNICATION TERMINAL
11 COMMUNICATION UNIT
12 CONTROL UNIT
20 COMMUNICATION TERMINAL
21 MICROPHONE
22 SPEAKER
23 DISPLAY UNIT
24 APPLICATION
25 INPUT UNIT
30 SERVER
40 MONITORING TERMINAL
41 COMMUNICATION UNIT
42 MONITORING UNIT

What is claimed is:

1. A communication terminal comprising:
at least one memory storing instructions, and
at least one processor configured to execute the instructions to;
transmit an emergency message; and
disable a user's operation of the communication terminal or a function executed by a user's operation of the communication terminal after the emergency message is transmitted; and
start data communication with a monitoring terminal and transmits data to the monitoring terminal while the operation or the function is disabled.

2. The communication terminal according to claim 1, wherein when a response message to the emergency message or a monitoring command message for conducting remote monitoring is received from the monitoring terminal, the at least one processor is further configured to execute the instructions to disable the operation or the function.

3. The communication terminal according to claim 1, wherein when a monitoring end message indicating end of monitoring is received from the monitoring terminal, the at least one processor is further configured to execute the instructions to enable the disabled operation or the function having been disabled.

4. The communication terminal according to claim 1, wherein the at least one processor is further configured to execute the instructions to start a timer after disabling the function and, when the timer expires, enable the disabled operation or the function.

5. The communication terminal according to claim 1, wherein the at least one processor is further configured to execute the instructions to disable at least one of all functions executed by a user's operation.

6. The communication terminal according to claim 1, wherein the at least one processor is further configured to execute the instructions to transmit and receive data and messages through a server that relays communications with the monitoring terminal.

7. The communication terminal according to claim 6, wherein the at least one processor is further configured to execute the instructions to transmit, to the server, the emergency message containing priority information indicating priority of processing related to communication with the monitoring terminal.

8. A monitoring method comprising:
transmitting an emergency message;
disabling a user's operation of a communication terminal or a function executed by a user's operation of the communication terminal after the emergency message is transmitted; and
starting data communication with a monitoring terminal and transmitting data to the monitoring terminal while the operation or the function is disabled.

9. A non-transitory computer readable medium storing a program causing a computer to execute:
transmitting an emergency message;
disabling a user's operation of a communication terminal or a function executed by a user's operation of the communication terminal after the emergency message is transmitted; and
starting data communication with a monitoring terminal and transmitting data to the monitoring terminal while the operation or the function is disabled.
